(19) United States
(12) Patent Application Publication
(10) Pub. No.: US 2026/0193032 A1
(43) Pub. Date: Jul. 9, 2026

(54) REFUSE CONTAINER ORIENTATION SYSTEM

(71) Applicant: Oshkosh Corporation, Oshkosh, WI (US)

(72) Inventors: Brendan Chan, Oshkosh, WI (US); Roberto Santana Blanco, Oshkosh, WI (US)

(73) Assignee: Oshkosh Corporation, Oshkosh, WI (US)

(21) Appl. No.: 19/439,203

(22) Filed: Jan. 2, 2026

Related U.S. Application Data
(60) Provisional application No. 63/741,595, filed on Jan. 3, 2025.

(51) Int. Cl. B65F 3/04; B65F 3/02

(52) U.S. Cl. CPC B65F 3/04; B65F 2003/023; B65F 2003/0273

(57) ABSTRACT

Embodiments herein relate to a refuse vehicle including a chassis, a body coupled to the chassis, a lift assembly coupled to the body, and a grabber assembly coupled to the lift assembly for engaging a refuse container. The refuse vehicle further includes a container orientation system including one or more container rotation elements coupled to the grabber assembly, and a motor coupled to the one or more container rotation elements and configured to move the one or more container rotation elements. The motor moves the one or more container rotation elements to move the refuse container into a desired orientation for depositing refuse into the refuse vehicle.

### CROSS-REFERENCE TO RELATED APPLICATIONS

This application claims the benefit of and priority to U.S. Provisional Patent Application No. 63/741,595, filed Jan. 3, 2025, the entire contents of which are hereby incorporated by reference herein.

### BACKGROUND

The present disclosure relates generally to the field of refuse vehicles. In this case, the present disclosure also relates to systems aiding the collection of refuse for transporting the refuse to a disposal site, such as a landfill, recycling center, composting facility, or organics processing facility.

### SUMMARY

One embodiment relates to a refuse vehicle including a chassis, a body coupled to the chassis, a lift assembly coupled to the body, and a grabber assembly coupled to the lift assembly for engaging a refuse container. The refuse vehicle further includes a container orientation system including one or more container rotation elements coupled to the grabber assembly, and a motor coupled to the one or more container rotation elements and configured to move the one or more container rotation elements. The motor moves the one or more container rotation elements to move the refuse container into a desired orientation for depositing refuse into the refuse vehicle.

In some embodiments, the grabber assembly includes a first grabber arm and a second grabber arm for engaging the refuse container, and the one or more container rotation elements include one or more rollers. In some embodiments, container orientation system further includes the one or more container rotation elements including a first roller coupled to the first grabber arm, and the motor coupled to the first roller and configured to move the first roller. The motor moves the first roller to move the refuse container into a desired orientation for depositing refuse into the refuse vehicle. In some embodiments, the one or more container rotation elements further include a second roller coupled to the second grabber arm and configured to move based on a movement of the first roller to move the refuse container into the desired orientation. In some embodiments, the one or more container rotation elements are configured to rotate about an axis of rotation, where the axis of rotation is substantially vertical to a ground surface.

In some embodiments, the grabber assembly includes a first grabber arm and a second grabber arm for engaging the refuse container. The one or more container rotation elements include one or more conveyors. In some embodiments, the container orientation system further includes the one or more container rotation elements including a first conveyor coupled to the first grabber arm, and the motor coupled to the first conveyor and configured to move the first conveyor. The motor moves the first conveyor to move the refuse container into a desired orientation for depositing refuse into the refuse vehicle. In some embodiments, the one or more container rotation elements further include a second conveyor coupled to the second grabber arm and configured to move based on a movement of the first conveyor to move the refuse container into the desired orientation.

In some embodiments, the one or more container rotation elements further include one or more conveyors movably coupled to the one or more rollers. The motor is configured to rotate at least one or the one or more rollers to move the at least one of the one or more conveyors. In some embodiments, the motor of the container orientation system is mounted on the grabber assembly of the refuse vehicle.

In some embodiments, the refuse vehicle further includes a controller communicably coupled to the container orientation system. The controller configured to receive sensor data indicative of an orientation of the refuse container from a sensor coupled to the grabber assembly, and apply a container orientation model to the sensor data to determine the orientation of the refuse container.

Another embodiment relates to a refuse vehicle including a chassis, a body coupled to the chassis, a lift assembly coupled to the body, a grabber assembly coupled to the lift assembly for engaging a refuse container, a container orientation system including one or more container rotation elements coupled to the grabber assembly, a motor coupled to the one or more container rotation elements, and a controller communicably coupled to the container orientation system. The controller is configured to receive sensor data indicative of an orientation of the refuse container from a sensor coupled to the grabber assembly, apply a container orientation model to the sensor data to determine the orientation of the refuse container, and control the motor to move the refuse container based on the orientation.

In some embodiments, the controller is further configured to determine, based on the orientation of the refuse container and the container orientation model, a rotational time for the motor, where the motor rotating for the rotational time moves the refuse container into a desired orientation. In some embodiments, the grabber assembly includes a first grabber arm and a second grabber arm for engaging the refuse container, and where the one or more container rotation elements includes a first roller coupled to the first grabber arm, and the motor coupled to the first roller and configured to move the first roller. The motor moves the first roller to move the refuse container into a desired orientation for depositing refuse into the refuse vehicle, based on the orientation of the refuse container. In some embodiments, the controller is further configured to transmit an output indicative of the orientation of the refuse container to a user device of the refuse vehicle, where an operator of the refuse vehicle operates the container orientation system based on the output to move the refuse container to a desired orientation from the orientation.

Another embodiment relates to a method for orienting a refuse container. The method including receiving sensor data indicative of an orientation of the refuse container, determining the orientation of the refuse container by applying a container orientation model to the sensor data, and operating a container orientation system to move the refuse container into a desired orientation.

In some embodiments, the method further includes lifting the refuse container to deposit refuse from the refuse container into a refuse vehicle, based on the refuse container being positioned in the desired orientation. In some embodiments, determining the orientation of the refuse container by applying the container orientation model to the sensor data includes comparing the sensor data to training data indicative of an orientation of the refuse container.

In some embodiments, operating the container orientation system to move the refuse container into the desired orientation includes rotating a roller via a motor, where the roller is movably coupled to a grabber arm of a refuse vehicle. The grabber arm engages the refuse container, and the roller moves the refuse container into the desired orientation. In some embodiments, operating the container orientation system to move the refuse container into the desired orientation includes moving a conveyor via a motor, where the conveyor is movably coupled to a grabber arm of a refuse vehicle. The grabber arm engages the refuse container, and the conveyor moves the refuse container into the desired orientation.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system that may be used by any of the refuse vehicles of FIGS. 1-3, according to an exemplary embodiment;

FIG. 5 is a diagram illustrating a collection route for autonomous transport and collection by a refuse vehicle, according to an exemplary embodiment;

FIG. 6 is a top view of a container orientation system, according to an exemplary embodiment;

FIG. 7 is a top view of the container orientation system, according to another exemplary embodiment;

FIG. 8 is a top view of the container orientation system with a refuse container in a desired orientation, according to an exemplary embodiment;

FIG. 9 is a diagram for controlling the container orientation system using a container orientation model, according to an exemplary embodiment.

FIG. 10 is a diagram of a method for orienting a container, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Refuse vehicles (e.g., garbage trucks, waste collection trucks, sanitation trucks, etc.) are vehicles configured to collect, process, and transport refuse. Referring generally to the Figures, various embodiments of refuse vehicles including a container orientation system for detecting refuse can orientation and moving a refuse container into a desired orientation to deposit refuse into a refuse vehicle are shown. In some embodiments, the refuse container orientation system is configured to determine refuse can orientation using a container orientation model (e.g., a machine learning model) applied to sensor data from one or more sensors onboard the refuse vehicle.

According to an exemplary embodiment, a refuse vehicle includes a chassis, a body coupled to the chassis, a lift assembly coupled to the body, and a grabber assembly coupled to the lift assembly for engaging a refuse container. The refuse vehicle further includes a container orientation system coupled to the grabber assembly and/or another location along the vehicle. In some embodiments, the container orientation system includes one or more container rotation elements (e.g., rollers, conveyors, etc.) coupled to the grabber assembly, and a motor coupled to the one or more container rotation elements and configured to move the one or more container rotation elements.

The refuse can orientation system may be configured to control the motor to move the one or more container rotation elements to move the refuse container into a desired orientation for depositing refuse into the refuse vehicle.

The refuse can orientation systems of the present disclosure can automatically reposition the container during the pickup operation and before lifting the container into the vehicle, which can improve retention of refuse material during a lift operation (which may otherwise be deflected or captured by the lid if the refuse container is in an improper orientation during lifting). Such a system can also eliminate the need for operators/drivers to exit the refuse vehicle to manually rotate the refuse container into the desired orientation prior to pickup, thereby improving operator productivity and the overall efficiency of the refuse collection process (e.g., reducing costs (e.g., fuel) associated with time of operation, and reducing fees to the end customer). Such manual manipulation can also increase safety risks to the operator/driver. The refuse can orientation systems described herein allow for repositioning of the container with the operator safely positioned within the refuse vehicle, which can save time and increase the efficiency of the refuse collection operation.

### Refuse Vehicle

### Front-loading Configuration

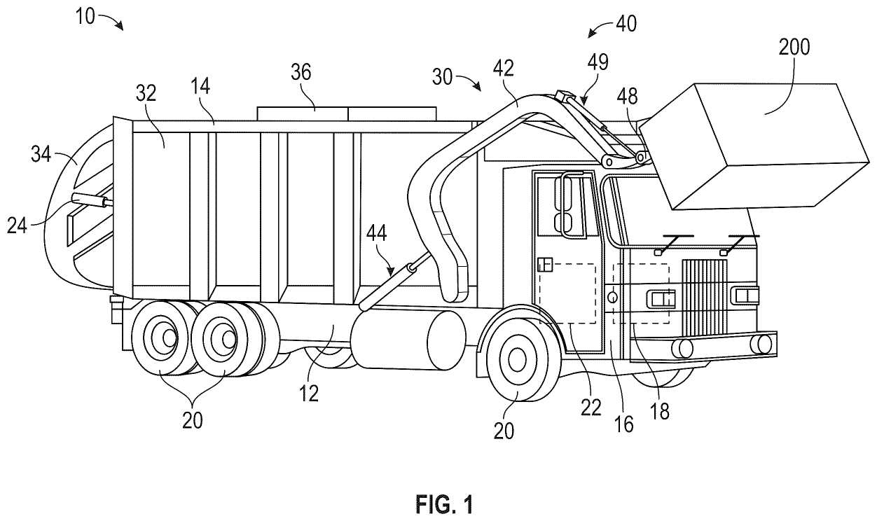

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment 200 as described in greater detail in U.S. application Ser. No. 17/558,183, filed Dec. 12, 2021, the entire disclosure of which is incorporated by reference herein.

### Rear-loading Configuration

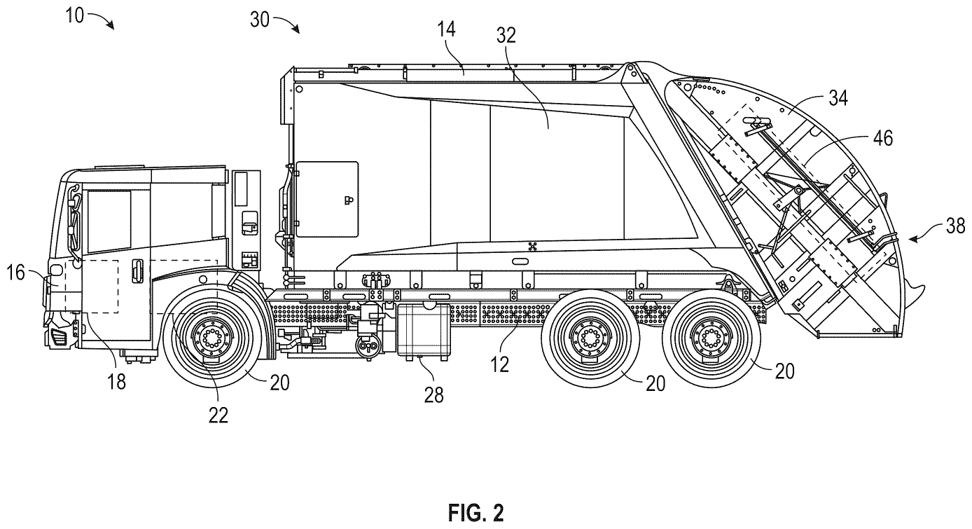

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-loading Configuration

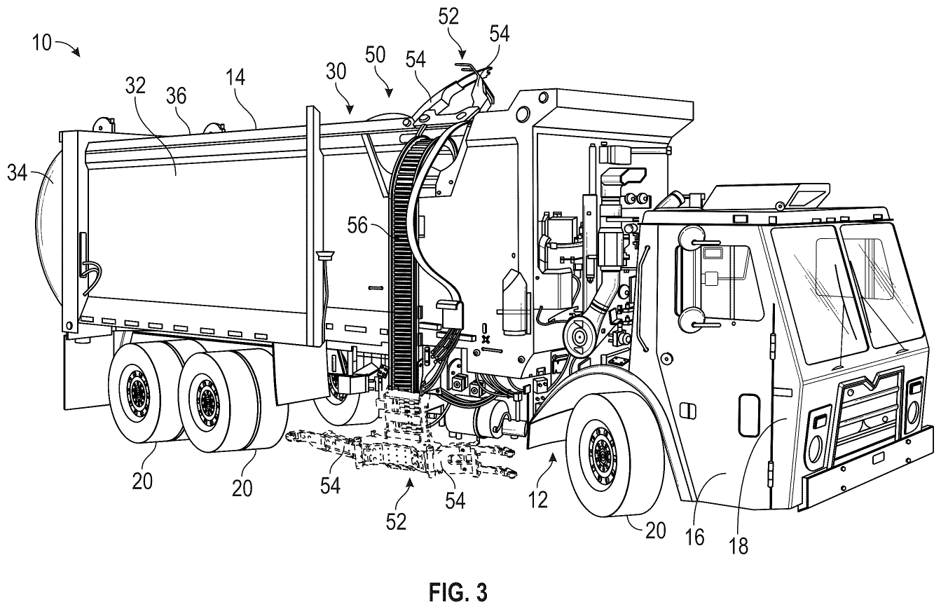

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

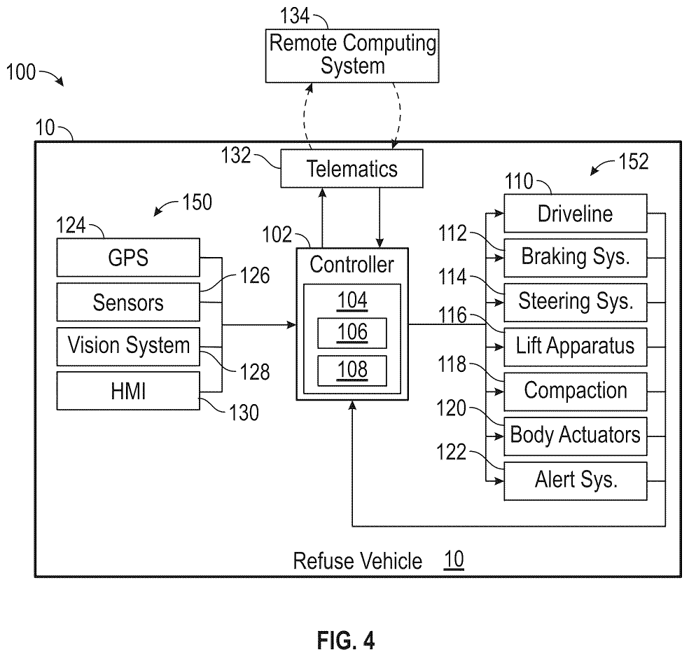

Referring to FIG. 4, the refuse vehicle 10 may include a control system 100 that is configured to facilitate operation of the refuse vehicle 10, or components thereof. In some embodiments, the control system 100 is configured to provide autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 50, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, imagings, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein. Although various aspects of autonomous operation may be implemented by the controller 102, it should be understood that the controller 102 may also be configured to facilitate operation of the refuse vehicle by a vehicle operation, for example, based on operator inputs to the HMI 130.

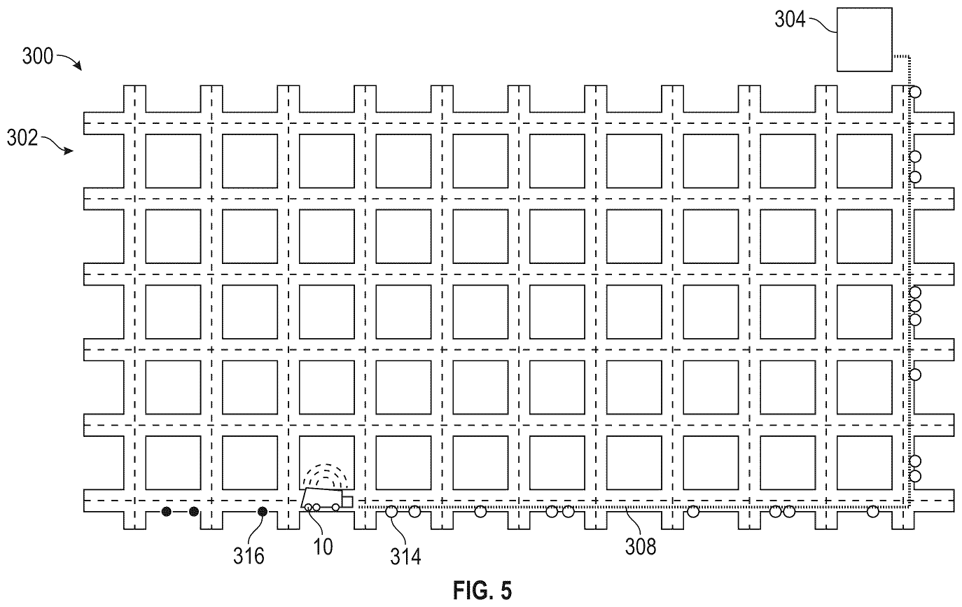

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

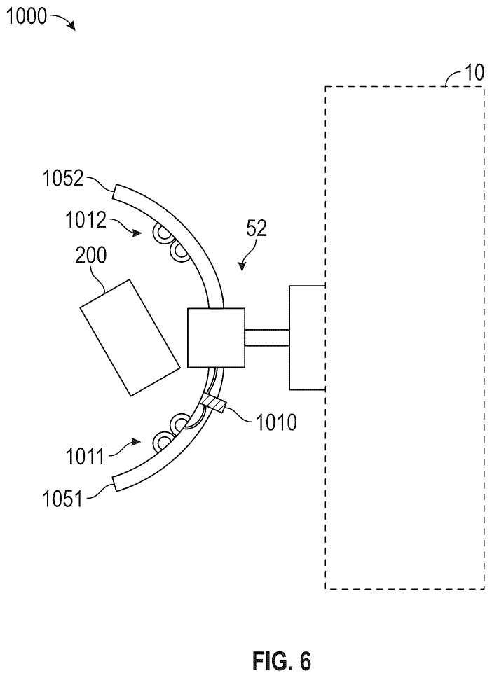

Referring to FIGS. 3 and 5-8, the refuse vehicle 10 includes a container orientation system 1000. For example, the refuse vehicle 10 may be in the side-loading configuration. The container orientation system 1000 is coupled to the grabber assembly 52. The grabber arms 54 engage the refuse container 200 and the container orientation system 1000 moves the refuse container 200 into a desired orientation 1110 for depositing refuse into the refuse vehicle 10. For example, the desired orientation 1110 is where the refuse container 200 is facing the refuse vehicle 10 (e.g., a front of the refuse container 200 faces the refuse vehicle 10, the lid of the refuse container 200 is positioned to open away from the refuse vehicle 10, a hinged connection between the lid and the container faces outward from the vehicle and/or is spaced apart from the lift mechanism by the container, a lateral axis of the refuse container 200 defined by the hinged connection is substantially parallel to a longitudinal axis of the refuse vehicle 10, etc.).

The container orientation system 1000 includes one or more container rotation elements (which may also be referred to as container reorientation elements) configured to move the refuse container 200 and positioned on the grabber arms 54. In some embodiments, and as shown, the container rotation elements includes one or more rollers 1005 (e.g., wheels, roller elements, etc.) that are rotatably coupled to the grabber arms 54. In some embodiments, the container rotation elements include conveyor belts or another form of actuator to rotate the refuse container 200 relative to the grabber arms 54.

In some embodiments, the container orientation system 1000 includes a first roller 1011 is positioned on the first grabber arm 1051. A second roller 1012 is positioned on the second grabber arm 1052. The first grabber arm 1051 includes a motor 1010 (e.g., an electric motor) connected to and configured to move (e.g., rotate) the first roller 1011. The motor 1010 is electrically coupled to the refuse vehicle 10 and/or batteries thereof. When the grabber assembly 52 engages the refuse container 200, the refuse container 200 may not be properly oriented. For example, the refuse container 200 may be facing at least partially away from the refuse vehicle 10 (e.g., a lid of the refuse container 200 would open toward the refuse vehicle 10, the lateral axis of the refuse container 200 is angled relative to the longitudinal axis of the refuse vehicle 10, etc.). The refuse container 200 not being properly oriented may interfere with depositing refuse into the refuse vehicle 10 (e.g., the lid may deflect refuse being deposited, refuse may spill onto a street, refuse may be trapped in the refuse container). In some embodiments, the one or more container rotation elements may be configured differently for moving the refuse container 200 into the desired orientation 1110 (e.g., a movable shaft configured to nudge the refuse container 200, a moveable claw arm configured to grip and move the refuse container 200).

In some embodiments, the first roller 1011 is positioned on the first grabber arm 1051, where the first roller 1011 rotates around an axis of rotation extending vertically from the ground (e.g., a ground surface, etc.). For example, a clockwise rotation of the first roller 1011 rotates the refuse container 200 in a counterclockwise direction. The refuse container 200 then rotates the second roller 1012 in the clockwise direction. The second roller 1012 may be positioned on the second grabber arm 1052, where the second roller 1012 rotates around the axis of rotation extending vertically from the ground. The second roller 1012 is configured for free movement (e.g., free rotation) on the second grabber arm 1052. In some embodiments, the first roller 1011 and/or the second roller 1012 may be otherwise positioned for rotation. For example, the first roller 1011 and/or the second roller 1012 may be angled from the axis of rotation extending vertically from the ground, where the first roller 1011 and/or the second roller 1012 at least partially rotate around the axis of rotation extending substantially vertical from the ground (e.g., some component of the rotation of the one or more rollers 1005 is around the axis extending vertically from the ground).

When the grabber assembly 52 engages the refuse container 200, the first roller 1011 and the second roller 1012 also engage the refuse container 200. The motor 1010 moves (e.g., spins) the first roller 1011 to provide a force for rotating the refuse container 200. The second roller 1012 moves corresponding to movement of the first roller 1011, based on engaging the refuse container 200 and the refuse container 200 rotating, creating a force on the second roller 1012. The first roller 1011 and the second roller 1012 orient the refuse container 200 in the desired orientation 1110 for depositing the refuse into the refuse vehicle 10. In some embodiments, the second roller 1012 includes a free rolling element and/or guide roller that is not powered by a motor, which can reduce system complexity. In other embodiments, the second roller 1012 is also a powered roller (e.g., is coupled to the electric motor, or a second electric motor, etc.).

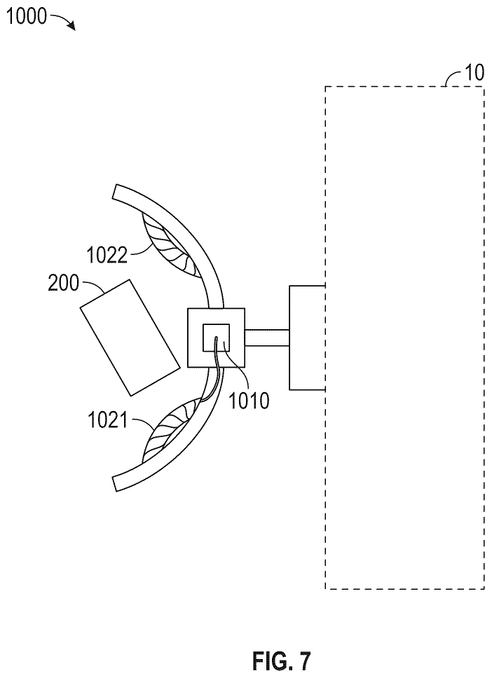

Referring to FIGS. 3 and 7, the container orientation system 1000 includes container rotation elements in the form of one or more conveyors (e.g., conveyor belts) positioned on the grabber arms 54. The one or more conveyers may be movably coupled to and positioned on the one or more rollers 1005, where the one or more rollers 1005 move the one or more conveyors. The one or more conveyors are configured to provide the force for moving the refuse container 200. In some embodiments, a first conveyor 1021 is positioned on the first grabber arm 1051. The first conveyor 1021 is movably coupled at least partially around the first roller 1011. The first conveyor 1021 extends a length along the first grabber arm 1051. The motor 1010 is configured to move the first conveyor 1021 (e.g., to move the first roller 1011 to move the first conveyor 1021). The motor 1010 may be positioned on the grabber assembly 52 (e.g., on a body portion of the grabber assembly 52). The motor 1010 may be positioned on the lift assembly 50. A second conveyor 1022 is positioned on the second grabber arm 1052. The second conveyor 1022 is movably coupled at least partially around the second roller 1012. The second conveyor 1022 extends a length along the second grabber arm 1052. The second conveyor 1022 is configured for free movement based on movement of the refuse container 200. When the grabber assembly 52 engages the refuse container 200, the first conveyor 1021 and the second conveyor 1022 also engage the refuse container 200. The motor 1010 moves (e.g., spins) the first roller 1011 to move the first conveyor 1021 and provide the force for rotating the refuse container 200. The second conveyor 1022 moves corresponding to movement of the first conveyor 1021, based on engaging the refuse container 200 and the refuse container 200 rotating, creating the force on the second conveyor 1022. The first conveyor 1021 and the second conveyor 1022 orient the refuse container 200 in the desired orientation 1110 for depositing the refuse into the refuse vehicle 10.

In some embodiments, additional rollers may be configured on the first grabber arm 1051 and/or the second grabber arm 1052. The additional rollers may be positioned adjacent to the first roller 1011 and/or the second roller 1012. In some embodiments, the one or more container rotation elements may include 1, 2, 3, 4 or more container rotation elements. For example, the one or more rollers 1005 may include 1, 2, 3, 4 or more rollers. In some embodiments, the first conveyor 1021 and/or the second conveyor 1022 may be positioned around one or more rollers 1005 on each of the grabber arms 54. Additional conveyors may be used on either of the grabber arms 54.

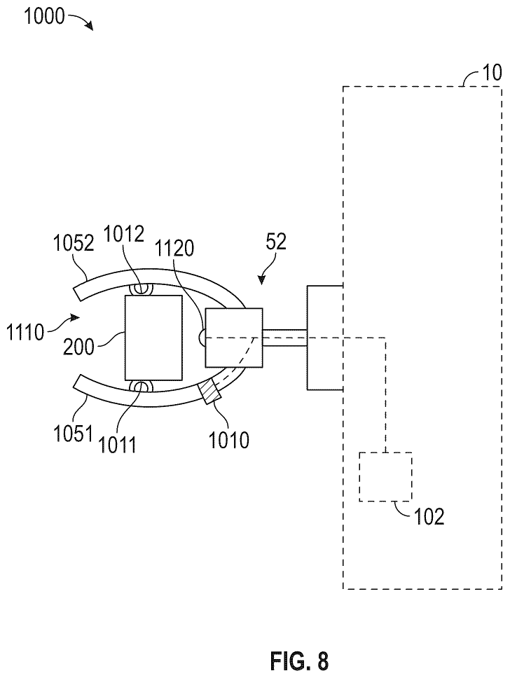

Referring to FIG. 8, the refuse vehicle 10 includes the controller 102, as described herein, communicable coupled to the container orientation system 1000 (e.g., to the motor 1010). In some embodiments, the controller 102 may be the controller 102, as described herein. In some embodiments, the controller 102 may be a separate controller for the container orientation system 1000, where the controller is communicably coupled to the controller 102 of the refuse vehicle 10. In some embodiments, the container orientation system 1000 may be controlled by a local (e.g., controller 102) and/or a remote controller.

In some embodiments, the operator of the refuse vehicle 10 may operate the container orientation system 1000. The operator may press a button to stop and/or start the motor 1010 to move the refuse container 200, where the operator uses visual feedback to determine when the refuse container 200 is in the desired orientation 1110. In some embodiments, the refuse vehicle 10 may include a camera to provide imaging of the container orientation system 1000 moving the refuse container 200 (e.g., a camera on a side of the refuse vehicle 10 configured for the operator to observe the container orientation system 1000 operating from the cab 16 of the refuse vehicle 10). In some embodiments, the container orientation system 1000 may operate autonomously to move the refuse container 200 into the desired orientation 1110. In some embodiments, once the refuse container 200 is in the desired orientation 1110, the refuse vehicle 10 may use the lift assembly 50 to deposit the refuse into the refuse vehicle 10, as described herein.

### Machine Learning Model for Refuse Container Orientation

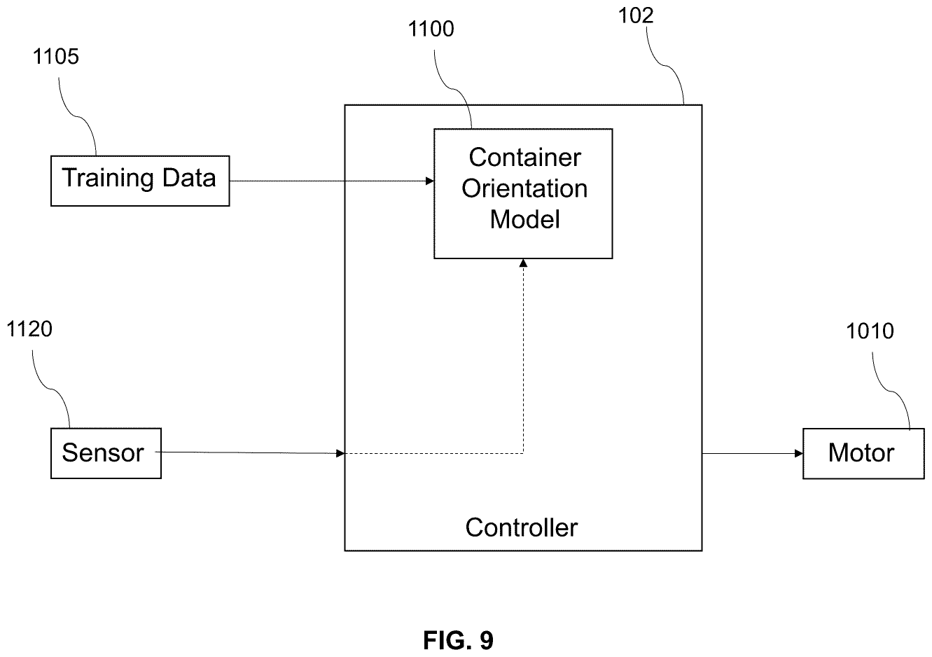

Referring to FIGS. 3 and 8-9, the refuse vehicle 10 includes a refuse can orientation system that is configured to determine an orientation of the refuse container 200. In some embodiments, the refuse vehicle 10 further includes the controller 102 implementing a machine learning algorithm, shown as a container orientation model 1100. The refuse vehicle 10 may use the container orientation model 1100 in conjunction with the container orientation system 1000 to move the refuse container 200 into the desired orientation 1110. A sensor 1120 (e.g., a camera) detects the refuse container 200. The sensor 1120 may be coupled to the grabber assembly 54 and/or otherwise coupled to the refuse vehicle 10. The sensor 1120 is communicably coupled to the controller 102, where the sensor 1120 sends sensor data (e.g., image data) indicative of the orientation of the refuse container 200 to the controller 102. The controller 102, based on applying the container orientation model 1100 to the sensor data, determines the orientation of the refuse container 200. The controller 102 outputs a first output indicative of the orientation of the refuse container 200, based on applying the container orientation model 1100 to the sensor data. The first output may be the orientation of the refuse container 200. Based on the first output (e.g., the orientation of the refuse container 200), the container orientation system 1000 may be operated to move the refuse container 200 into the desired orientation 1110.

The container orientation model 1100 may be a machine learning model configured to determine the orientation of refuse containers. The container orientation model 1100 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof. The controller may acquire (e.g., collect, receive, etc.) a training data 1105 to use in training the container orientation model (e.g., by least squares, or by training the neural network). In some embodiments, the container orientation model can be configured using various unsupervised and/or supervised training operations. The container orientation model can be configured using training data 1105 from various domain-agnostic and/or domain-specific data sources, including but not limited to various forms of text, speech, audio, image, and/or video data, or various combinations thereof. The training data 1105 can include a plurality of training data 1105 elements (e.g., training data 1105 instances). Each training data 1105 element can be arranged in structured or unstructured formats; for example, the training data 1105 element can include an example output mapped to an example input. The training data 1105 can include data that is not separated into input and output subsets (e.g., for configuring the first model to perform clustering, classification, or other unsupervised ML operations). The training data 1105 can include human-labeled information, including but not limited to feedback regarding outputs of the models. This can allow the system to generate more human-like outputs. In some embodiments, the container orientation model 1100 may be stored and/or used on a local (e.g., controller 102) and/or a remote controller.

In some embodiments, the training data 1105 may include sensor data indicative of an orientation of the refuse container 200. The training data 1105 may include the sensor data (e.g., images of a refuse can) and a label element to indicate the orientation of the refuse container within the sensor data. For example, the sensor data may indicate that the refuse container 200 is oriented 20 degrees away from the refuse vehicle 10, which is accompanied by the label element of “20 degrees,” for training the container orientation model 1100. The sensor data corresponds to a type of sensor used as the sensor 1120 (e.g., an optical sensor such as a camera, LIDAR, radar, etc.). In some embodiments, the training data 1105 includes image data (e.g., images) of refuse containers positioned in different orientations. For example, the image data may depict the refuse container 200 oriented 20 degrees clockwise away from the refuse vehicle 10, with the label element of “20 degrees clockwise” accompanied. The image data corresponds to the sensor 1120 configured as the camera and/or a similar type of sensor. In other words, the controller 102 applying the container orientation model 1100 to the sensor data compares the sensor data to the training data 1105 to determine the orientation of the refuse container 200, where the orientations of the refuse containers in the training data 1105 are known.

In some embodiments, the first output may be in the form of the label element accompanying the sensor data input from the sensor 1120. For example, the controller 102 determines the orientation of the refuse container 200 by creating the label element for the sensor data, based on applying the container orientation model 1100 to the sensor data. The label element may also be used to indicate to the container orientation system 1000 which direction to move (e.g., spin, rotate) the motor 1010 for rotating the one or more rollers 1005 to move the refuse container 200.

In some embodiments, the operator of the refuse vehicle 10 may operate the container orientation system 1000 based on the first output of the container orientation model 1100. The first output (e.g., the orientation of the refuse container 200) is sent to the user device of the refuse vehicle 10 to communicate (e.g., transmit, send, etc.) the orientation to the operator. The operator may press a button to stop and/or start the motor 1010 to move the refuse container 200, where the operator uses visual feedback to determine when the refuse container 200 is in the desired orientation 1110. In some embodiments, the container orientation system 1000 may operate autonomously to move the refuse container 200 into the desired orientation 1110. The refuse vehicle 10 may drive next to the refuse container 200, use the container orientation model 1100 to determine the orientation of the refuse container 200, and then autonomously operate the container orientation system 1000 to move the refuse container 200 into the desired orientation 1110. The controller 102 may operate the motor 1010, based on determining the orientation of the refuse container 200 using the container orientation model 1100, to move the refuse container 200 to the desired orientation 1110. The controller 102 may stop operating the motor 1010 once the desired orientation 1110 is reached. In some embodiments, the controller 102 may operate the motor 1010 based on the sensor 1120 continually transmitting sensor data indicating the orientation of the refuse container 200. In other words, the controller 102 may continuously determine the orientation of the refuse container 200 until the refuse container 200 is in the desired orientation 1110.

In some embodiments, the controller 102 may operate the motor 1010 based on a second output (e.g., an operational output) of the container orientation model 1100. For example, the container orientation model 1100 may determine the second output as parameters for operating the container orientation system 1000 autonomously to move the refuse container 200 into the desired orientation 1110. The container orientation model 1100 may further include the training data 1105 may including data corresponding to operation of the container orientation system 1000 (e.g., operational metrics). For example, the data may be a rotational speed for the motor 1010 and/or a rotational time for the motor 1010. Other measurable and/or determinable metrics of the container orientation system 1000 may be used. The data may correspond to various orientations of the refuse container 200 (e.g., to degrees rotated). In other words, the data corresponding to operation of the container orientation system 1000 may be used to determine how to operate the motor 1010, based on the orientation of the refuse container 200, to move the refuse container 200 into the desired orientation 1110. In some embodiments, the container orientation model 1100 may track the operational metrics (e.g., performance) of the container orientation system 1000 for continuously training the container orientation model 1100. The training data 1105 may include the labeling element accompanying the operational metrics of the container orientation system 1000 based on the container orientation model 1100 determining the orientation of the refuse container 200.

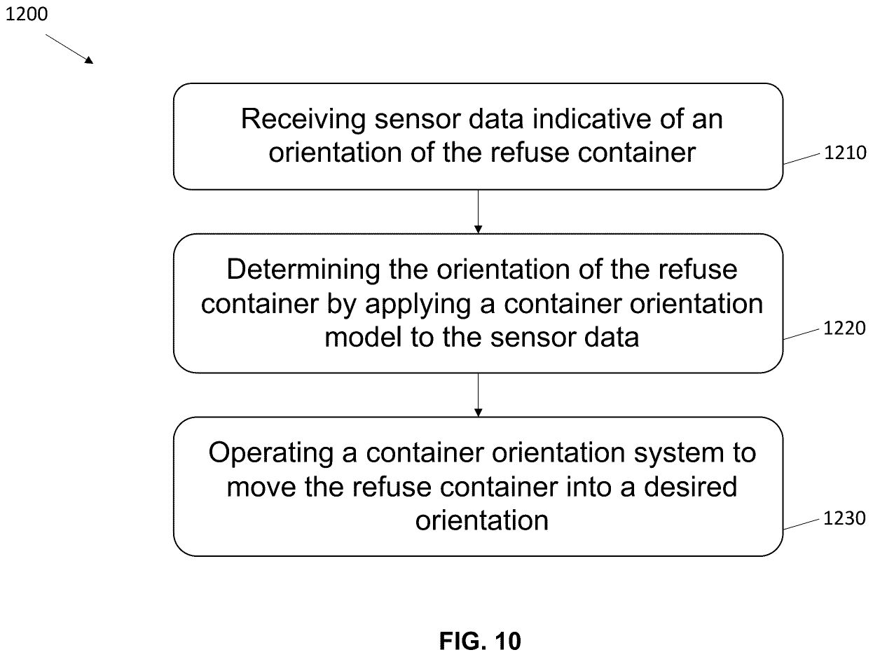

Referring to FIG. 10, a method 1200 for orienting a refuse container is depicted. In some embodiments, the method 1200 includes detecting the refuse container using a sensor. In some embodiments, an operator of the refuse vehicle may detect and/or indicate the refuse container.

The method 1200 includes receiving sensor data indicative of an orientation of the refuse container, at method step 1210. For example, the sensor data may be generated and/or received from a sensor, as described herein, such as the sensor 1120. The method 1200 further includes determining the orientation of the refuse container by applying a container orientation model to the sensor data, at method step 1220. For example, the container orientation model may be implemented as an embodiment of the container orientation model 1100, as described herein. The method 1200 further includes operating a container orientation system to move the refuse container into a desired orientation, at method step 1230. For example, the container orientation system may be an embodiment of the container orientation system 1000, as described herein (e.g., including the one or more rollers 1005, the one or more conveyors, etc.). In some embodiments, the method 1200 further includes depositing refuse contained in the refuse container into a refuse vehicle, once the refuse container is in the desired orientation. For example, depositing refuse into the refuse vehicle may include moving (e.g., lifting) the refuse container to deposit refuse from the refuse container into the refuse vehicle. The refuse container being in the desired orientation decreases spillage and/or the unsuccessful dumping of refuse when depositing said refuse into the refuse vehicle.

In some embodiments, the method 1200 may be carried out by local (e.g., controller 102) and/or remote controllers. The method 1200 may be used with an embodiment of the container orientation system 1000 and/or the container orientation model 1100, as described herein. In some embodiments, the method 1200 may include additional, fewer, and/or a different order of method steps.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a body coupled to the chassis;
a lift assembly coupled to the body;
a grabber assembly coupled to the lift assembly for engaging a refuse container; and
a container orientation system comprising:
one or more container rotation elements coupled to the grabber assembly;
a motor coupled to the one or more container rotation elements and configured to move the one or more container rotation elements; and
wherein the motor moves the one or more container rotation elements to move the refuse container into a desired orientation for depositing refuse into the refuse vehicle.

2. The refuse vehicle of claim 1, wherein the grabber assembly comprises a first grabber arm and a second grabber arm for engaging the refuse container, the one or more container rotation elements comprising one or more rollers.

3. The refuse vehicle of claim 2, wherein the container orientation system further comprises:
the one or more container rotation elements comprising a first roller coupled to the first grabber arm;
the motor coupled to the first roller and configured to move the first roller; and
wherein the motor moves the first roller to move the refuse container into a desired orientation for depositing refuse into the refuse vehicle.

4. The refuse vehicle of claim 3, wherein the one or more container rotation elements further comprise a second roller coupled to the second grabber arm and configured to move based on a movement of the first roller to move the refuse container into the desired orientation.

5. The refuse vehicle of claim 1, wherein the one or more container rotation elements are configured to rotate about an axis of rotation, wherein the axis of rotation is substantially vertical to a ground surface.

6. The refuse vehicle of claim 1, wherein the grabber assembly comprises a first grabber arm and a second grabber arm for engaging the refuse container, the one or more container rotation elements comprising one or more conveyors.

7. The refuse vehicle of claim 6, wherein the container orientation system further comprises:
the one or more container rotation elements comprising a first conveyor coupled to the first grabber arm;
the motor coupled to the first conveyor and configured to move the first conveyor; and
wherein the motor moves the first conveyor to move the refuse container into a desired orientation for depositing refuse into the refuse vehicle.

8. The refuse vehicle of claim 7, wherein the one or more container rotation elements further comprise a second conveyor coupled to the second grabber arm and configured to move based on a movement of the first conveyor to move the refuse container into the desired orientation.

9. The refuse vehicle of claim 2, wherein the one or more container rotation elements further comprise one or more conveyors movably coupled to the one or more rollers, the motor configured to rotate at least one or the one or more rollers to move the at least one of the one or more conveyors.

10. The refuse vehicle of claim 1, wherein the motor of the container orientation system is mounted on the grabber assembly of the refuse vehicle.

11. The refuse vehicle of claim 1, further comprising a controller communicably coupled to the container orientation system, the controller configured to:
receive sensor data indicative of an orientation of the refuse container from a sensor coupled to the grabber assembly; and
apply a container orientation model to the sensor data to determine the orientation of the refuse container, 12. A refuse vehicle comprising:
a chassis;
a body coupled to the chassis;
a lift assembly coupled to the body;
a grabber assembly coupled to the lift assembly for engaging a refuse container;
a container orientation system comprising:
one or more container rotation elements coupled to the grabber assembly;
a motor coupled to the one or more container rotation elements; and
a controller communicably coupled to the container orientation system, the controller configured to:
receive sensor data indicative of an orientation of the refuse container from a sensor coupled to the grabber assembly;
apply a container orientation model to the sensor data to determine the orientation of the refuse container; and
control the motor to move the refuse container based on the orientation.

13. The refuse vehicle of claim 12, wherein the controller is further configured to determine, based on the orientation of the refuse container and the container orientation model, a rotational time for the motor, wherein the motor rotating for the rotational time moves the refuse container into a desired orientation.

14. The refuse vehicle of claim 12, wherein the grabber assembly comprises a first grabber arm and a second grabber arm for engaging the refuse container, and wherein the one or more container rotation elements comprises:
a first roller coupled to the first grabber arm;
the motor coupled to the first roller and configured to move the first roller; and
wherein the motor moves the first roller to move the refuse container into a desired orientation for depositing refuse into the refuse vehicle, based on the orientation of the refuse container.

15. The refuse vehicle of claim 12, wherein the controller is further configured to transmit an output indicative of the orientation of the refuse container to a user device of the refuse vehicle, wherein an operator of the refuse vehicle operates the container orientation system based on the output to move the refuse container to a desired orientation from the orientation.

16. A method for orienting a refuse container, the method comprising:
receiving sensor data indicative of an orientation of the refuse container;
determining the orientation of the refuse container by applying a container orientation model to the sensor data; and
operating a container orientation system to move the refuse container into a desired orientation.

17. The method of claim 16, further comprising lifting the refuse container to deposit refuse from the refuse container into a refuse vehicle, based on the refuse container being positioned in the desired orientation.

18. The method of claim 16, wherein determining the orientation of the refuse container by applying the container orientation model to the sensor data comprises comparing the sensor data to training data indicative of an orientation of the refuse container.

19. The method of claim 16, wherein operating the container orientation system to move the refuse container into the desired orientation comprises rotating a roller via a motor, the roller movably coupled to a grabber arm of a refuse vehicle, wherein the grabber arm engages the refuse container, and the roller moves the refuse container into the desired orientation.

20. The method of claim 16, wherein operating the container orientation system to move the refuse container into the desired orientation comprises moving a conveyor via a motor, the conveyor movably coupled to a grabber arm of a refuse vehicle, wherein the grabber arm engages the refuse container, and the conveyor moves the refuse container into the desired orientation.
